(19) United States
(12) Patent Application Publication
(10) Pub. No.: US 2012/0149344 A1
(43) Pub. Date: Jun. 14, 2012

(54) Method and System for Remote Notification and Answering of a Visitor at a Dooor

(76) Inventor: Sudeep Dasgupta, San Jose, CA (US)

(21) Appl. No.: 12/964,432

(22) Filed: Dec. 9, 2010

(51) Int. Cl. G08B 25/00; H04W 4/00

(52) U.S. Cl. 455/414.1; 340/307

(57) ABSTRACT

Methods and systems in accordance with the present invention provide a Bluetooth, wifi or other wirelessly connected door answering system. This system may include a Bluetooth or wifi device, for example, which may be affixed to or near a door and is enabled to communicate with a software application running on a mobile telephone, personal computer (“PC”), laptop or other portable computer, or any other appropriate connected device with a processor and user interface. In some implementations, this system may allow the user to communicate with the visitor via audio, video, and/or textual methods of communication.

This generally relates to devices used to alert of a visitor's presence and to answer a door, such as a doorbell.

### BACKGROUND

The 21^{st} century has seen a rise in the number of people who work from home. Even though they are in their homes, these people are not at leisure, and they typically place a great premium on efficient use of their time. Further, many people who do not work from home still place a similar premium on efficient use of their time while at home. This premium on time usage dictates that these people often prefer not to physically answer the front door whenever a visitor calls.

Additionally, many people live in homes which are large and/or comprise multiple floors and/or levels. These people regularly find themselves at great distances from their front door when they are inside their homes. The need to move a great distance and/or up or down multiple stairs dictates that they often prefer not to physically answer the front door whenever a visitor calls.

Finally, many elderly and/or handicapped people live alone or spend part of their time alone in their homes. Even when they are in close proximity to their front door, their motile difficulties dictate that they too often prefer not to physically answer their front door when a visitor calls.

Often, callers at the door are not friends or other desired guests, but instead may be people whom the user does not wish to interact with, such as door-to-door salespeople or criminals. However, the limitations on conventional systems often dictate that a user interacts with callers at the door, or come within close proximity to the door to discern who is calling, potentially limiting their ability to avoid such unwanted visitors. Additionally, if a criminal or other suspicious individual is at the door, the user, upon realizing this, may be far from a landline or cellular telephone and thus, may be unable to call emergency responders via, for example, dialing “911.”

Conventional doorbells and/or knockers merely provide an aural indication that a visitor is at the front door. They create a loud noise which may prompt the occupants to answer the door, but in order to answer the door, the occupant is required to physically travel to the front door and communicate with the visitor by talking through the door and/or physically opening the door to discern the visitor's identity. Additionally, because conventional systems rely on an aural prompt, they are not always effective, for example if the user is listening to music or other audio, which may drown out the sound of the doorbell or knocker and prevent the user from being alerted to the presence of a visitor. Further, there may be parts of the home which do not have a doorbell speaker, or in which the sound of a knocker cannot be heard, in which case the user would also not be alerted to the presence of the visitor.

Conventional intercom systems, especially those in large homes, may require a great deal of wiring and/or hardware in order to provide adequate coverage throughout the home. Installation of such systems is time consuming and expensive.

Conventional call boxes, such as those at the entrance of some commercial and/or apartment buildings, route analog calls made from the call box through a service provider and into the recipient's “landline,” a telephone line that travels through a solid medium such as metal wire or optical fibers. Alternatively, the analog call may be routed to a cellular phone, but it is still routed as a phone call. In these scenarios, the occupant does not have to travel to the front door to “answer” it, but they do have to move to and answer either a telephone connected to the landline where callbox calls are routed, or to their cellular phone, either of which may be at some distance from various other points within the house or other building, and they will be charged for minutes on their cellular telephone plan.

Accordingly, there is a desire for a Bluetooth, wife, or other wirelessly connected door answering system.

### SUMMARY

In accordance with the methods and systems consistent with the present invention, a data processing system is provided for notification of a visitor at a door, comprising a wireless door answering device connected to the door. The wireless door answering device comprises a user interface configured to receive an indication of a user's presence at the door, and a transmitter configured to transmit a notification wirelessly to a wireless device indicating that the user has interacted with the user interface to indicate the user's presence at the door.

In one implementation, a method is provided in a data processing system is provided for notification of a visitor at a door, comprising receiving, from a user, an indication of a user's presence at the door, and sending, wirelessly, a notification to a wireless device indicating that the user is at the door.

### BRIEF DESCRIPTION OF THE DRAWINGS

FIG. 1 illustrates an exemplary embodiment of a wireless door answering system made in accordance with methods and systems consistent with the present invention.

FIG. 2 depicts another exemplary embodiment of a wireless door answering system in accordance with methods and systems consistent with the present invention.

FIG. 3 depicts an exemplary embodiment of a cellular telephone and a door answering device in accordance with methods and systems consistent with the present invention.

FIG. 4 depicts a floor plan consistent with methods and systems in accordance with the present invention.

### DETAILED DESCRIPTION

Methods and systems in accordance with the present invention provide a Bluetooth, wifi or other wirelessly connected door answering system. This system may include a Bluetooth or wifi device, for example, which may be affixed to or near a door and is enabled to communicate with a software application running on a mobile telephone, personal computer (“PC”), laptop or other portable computer, or any other appropriate connected device with a processor and user interface. In some implementations, this system may allow the user to communicate with the visitor via audio, video, and/or textual methods of communication. In other implementations, this system may also allow the user to communicate with emergency personnel through their mobile telephone, PC, laptop or other portable computer, or any other appropriate device which the application is running on, for example by placing a phone call to 911.

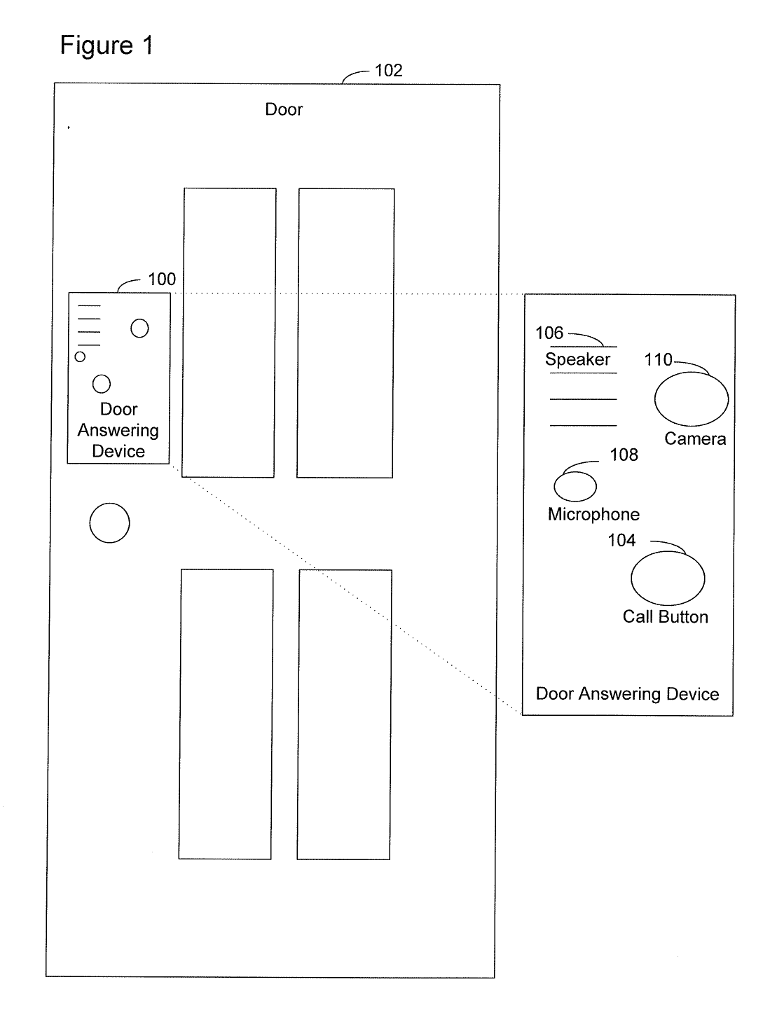

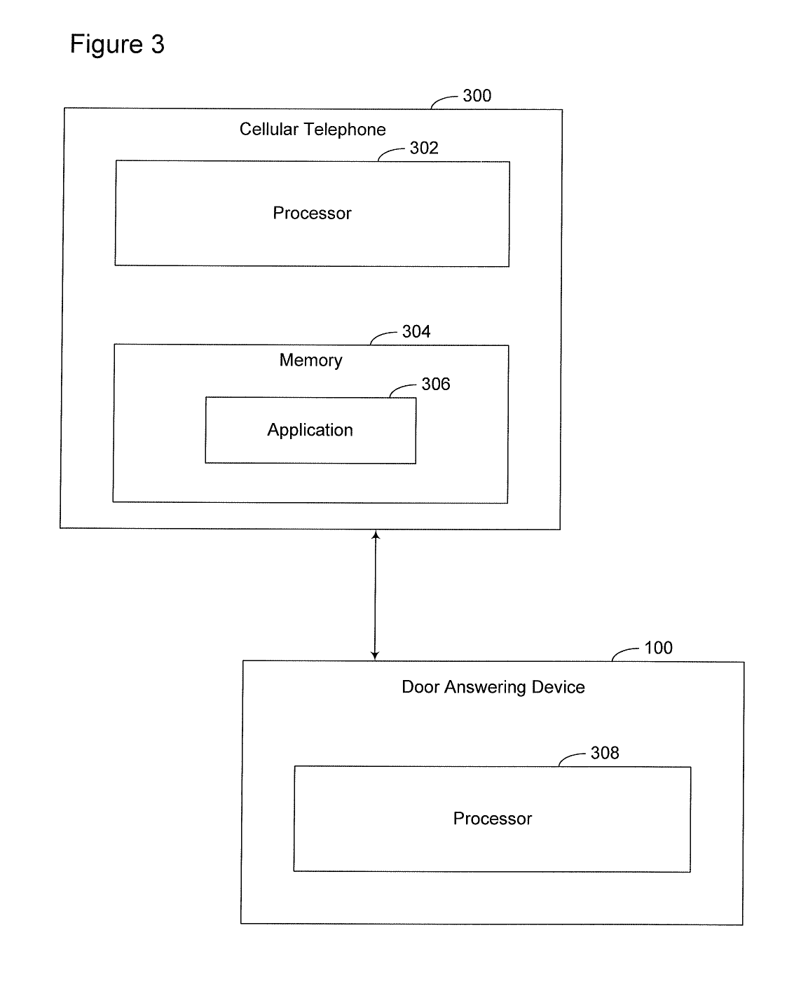

FIG. 1 illustrates an exemplary embodiment of a wireless door answering system made in accordance with methods and systems consistent with the present invention. The implementation of FIG. 1 is one wherein Door Answering Device 100 is mounted on Door 102. In some implementations, Door Answering Device 100 may be powered by a battery, and in other implementations it may be hardwired to an electrical system. In some implementations, Door Answering Device 100 may be in a casing made of, for example, plastic, metal, glass, or any other appropriate material. An enlarged drawing of Door Answering Device 100 is also depicted showing Door Answering Device 100 comprising Call Button 104, Speaker 106, Microphone 108, and Camera 110. When a visitor arrives at Door 102, the visitor may activate Call Button 104, for example by depressing it. When Call Button 104 is activated, the associated software application 306 (as shown on and discussed with respect to FIG. 3), such as an iPhone application from Apple, Inc., running on the user's mobile telephone, PC, laptop or other portable computer, or other appropriate device receives an alert or other notification message, and transmits that message wirelessly to the user via the electronic device the application is active on. In some implementations, the user receives a prompt on the user interface of the electronic device the application is active on. In some implementations, the prompt may give the user a choice to accept or deny the connection. Once the user accepts the connection, they may speak into the microphone on the device which the application is active on, and the audio signal will be transmitted by the application to Door Answering Device 100, where it may be heard by the visitor through Speaker 106. Additionally, once the user accepts the connection, the visitor may speak into microphone 108 and that audio signal will be transmitted by the application 306 to the user's electronic device the application is active on, where it may be heard by the user through the speaker on said electronic device. Further, Camera 110 may capture video of the scene in front of Door 102, including video of the visitor, and transmit the video signal to the user's electronic device the application is active on, where it may be seen by the user through the video interface on said electronic device. In one implementation, the user may have the option of placing an emergency call to 911 from the software application 306.

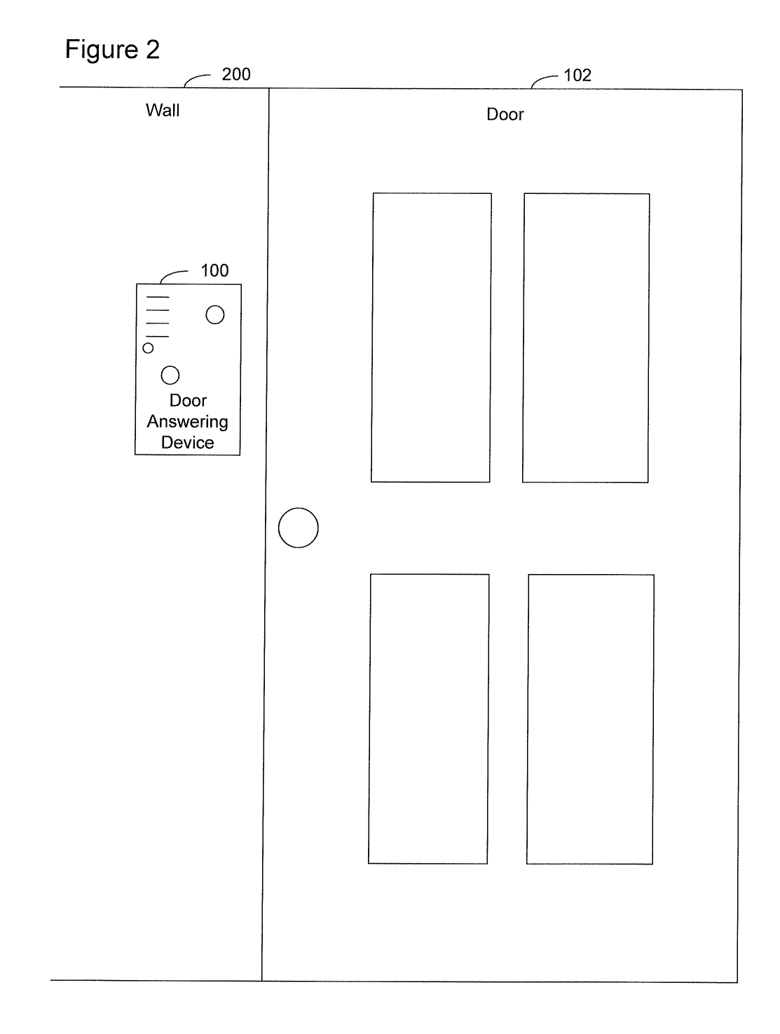

FIG. 2 depicts another exemplary embodiment of a wireless door answering system in accordance with methods and systems consistent with the present invention. In the implementation of FIG. 2, Door Answering Device 100 is mounted on Wall 200 adjacent to Door 102. The modes of operation of the device shown in FIG. 2 are similar to those of the device shown in FIG. 1. The implementation shown in FIG. 2 may be preferable, for example, because it allows the door to be removed and/or replaced without disruption and/or removal or replacement of the door answering system.

FIG. 3 depicts an exemplary embodiment of a cellular telephone and a door answering device in accordance with methods and systems consistent with the present invention. Cellular telephone 300 includes a Processor 302 for processing information. Cellular telephone 300 also includes a Memory 304, such as a random access memory (RAM) or other dynamic storage device, for storing information and instructions to be executed by processor 302. In addition, Memory 304 may be used for storing temporary variables or other intermediate information during execution of instructions to be executed by processor 302. Memory 304 includes an Application 306 for implementing the remote notification and door answering system in accordance with methods and systems consistent with the present invention. Door Answering Device 100 includes a Processor 308 for processing information. In some implementations, Door Answering Device 100 may be a wireless transmitter/receiver that may transmit and receive Bluetooth, wifi or other wireless signals. Door Answering Device 100 may include hardware, software, or any combination of hardware and software.

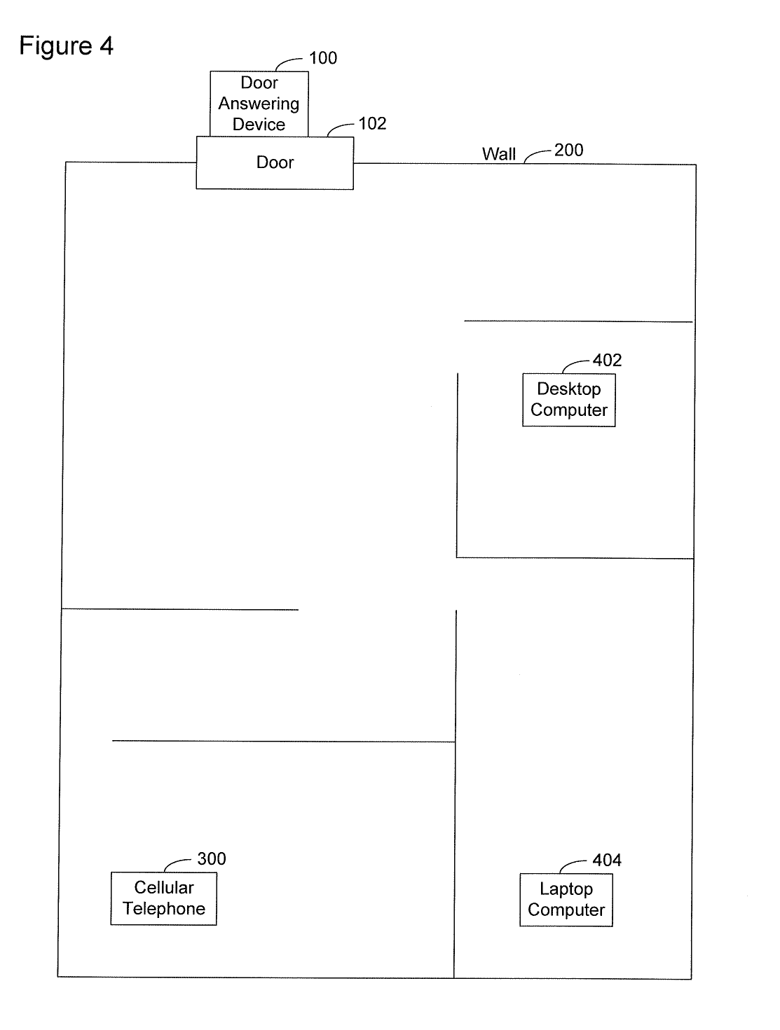

FIG. 4 depicts an exemplary floor plan consistent with methods and systems in accordance with the present invention. Door Answering Device 100 is mounted on Door 102. In other embodiments, Door Answering Device 100 may be mounted on Wall 200. Desktop Computer 402, Laptop Computer 404 and Cellular Telephone 300 are located inside the house at various distances from Door Answering Device 100. Desktop Computer 402, Laptop Computer 404, and Cellular Telephone 300 may each have the appropriate software Application 306 installed and running so that Door Answering Device 100 may communicate with each of them individually at the same time. In this way, the user is able to answer the door when a visitor arrives from various points within the user's home or other building without carrying an electronic device from room to room. In one implementation, data, images, voice and text may be saved locally on a pc, smart phone or a remote server, for example, in case a crime is committed so that it may be used as evidence.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A data processing system for notification of a visitor at a door, comprising:
a wireless door answering device connected to the door, comprising:
a user interface configured to receive an indication of a user's presence at the door; and
a transmitter configured to transmit a notification wirelessly to a wireless device indicating that the user has interacted with the user interface to indicate the user's presence at the door.

2. The data processing system of claim 1, wherein the wireless device is a mobile phone.

3. The data processing system of claim 2, wherein the mobile phone includes a software application configured to activate upon receipt of the wireless notification.

4. The data processing system of claim 3, wherein the software application displays to the user that the wireless door answering device has been activated.

5. The data processing system of claim 1, wherein the notification is a Bluetooth wireless transmission.

6. The data processing system of claim 1, where the notification is a wife wireless transmission.

7. The data processing system of claim 1, wherein the user interface includes one or more of: (1) a button, (2) a microphone, and (3) a motion sensor.

8. The data processing system of claim 7, wherein the wireless door answering device transmits audio to the wireless device.

9. The data processing system of claim 7, wherein the wireless door answering device transmits video to the wireless device.

10. The data processing system of claim 7, wherein the wireless door answering device transmits to multiple wireless devices.

11. The data processing system of claim 1, wherein the wireless device transmits data wirelessly to the wireless answering door device.

12. The data processing system of claim 11, wherein the data includes audio.

13. The data processing system of claim 11, wherein the data includes video.

14. The data processing system of claim 11, wherein the data includes text.

15. The data processing system of claim 1, wherein the wireless door answering device is attached to the door frame.

16. The data processing system of claim 1, wherein the wireless door answering device is attached to the door.

17. A method in a data processing system for notification of a visitor at a door, comprising:
Receiving, from a user, an indication of a user's presence at the door; and
sending, wirelessly, a notification to a wireless device indicating that the user is at the door.

18. The method of claim 17, wherein the notification is sent via a Bluetooth transmission.

19. The method of claim 17, wherein the notification is sent via a wifi transmission.

20. The method of claim 17, further comprising:
receiving the notification by the wireless device.

21. The method of claim 17, wherein the notification includes one or more of: (1) an indication of a button press, (2) voice data, and (3) an indication of motion sensed.
